(19) United States
(12) Patent Application Publication
(10) Pub. No.: US 2012/0204126 A1
(43) Pub. Date: Aug. 9, 2012

(54) INFORMATION PROCESSING APPARATUS, PROGRAM, AND SCREEN DISPLAY METHOD

(75) Inventor: Hiroshi YOSHIMURA, Kawasaki (JP)

(73) Assignee: FUJITSU LIMITED, Kawasaki-shi (JP)

(21) Appl. No.: 13/310,338

(22) Filed: Dec. 2, 2011

(30) Foreign Application Priority Data
Feb. 4, 2011 (JP) 2011-022881

(51) Int. Cl. G06F 3/048

(52) U.S. Cl. 715/778

(57) ABSTRACT

An information processing apparatus capable of running in parallel a plurality of OSs including a first OS and a second OS includes a first event controller and a second event controller. When the first OS granted a receiving right is enabled to accept a user authentication operation, if an event other than a predetermined first input event occurs, the first event controller instructs a display controller to perform processing to display a screen for accepting the authentication operation. If the predetermined first input event occurs, the second event controller instructs the display controller to perform processing to display the screen of the second OS currently not displayed.

### CROSS-REFERENCE TO RELATED APPLICATIONS

This application is based upon and claims the benefit of priority of the prior Japanese Patent Application No. 2011-22881, filed on Feb. 4, 2011, the entire contents of which are incorporated herein by reference.

### FIELD

The embodiments discussed herein are related to a method of screen display for use in an information processing apparatus capable of running a plurality of operating systems in parallel.

### BACKGROUND

Certain types of information processing apparatus are capable of running a plurality of operating systems in parallel. Some of such information processing apparatus are of the type that, under a given condition, make a transition to an operational state that does not accept any user input and that demands user authentication if the user input is to be enabled. In the following description, the operating system may be abbreviated as “OS”. Of the plurality of OSs running in parallel on the information processing apparatus, the OS currently running in the foreground may be described as the “foreground OS” and the OS currently running in the background as the “background OS”. On the other hand, the operational state that does not accept any user input may be referred to as the “operation locked state” and any other state as the “operation unlocked state”.

A multiple operating system switching control apparatus is known which is provided in a computer system equipped with an operating system switching function that switches the active operating system from a primary operating system to a secondary operating system in an exclusive manner. The multiple operating system switching control apparatus includes a primary operating system control unit which is put into operation when the primary operating system is active. The primary operating system control unit includes a switching request receiving unit which receives an operating system switching request that requests that the secondary operating system currently in a suspended state be switched in as the active operating system, a switching event notifying unit which notifies the secondary operating system or an application on the secondary operating system of the occurrence of event information that is contained in the received operating system switching request and that requests processing by the secondary operating system or by the application on the secondary operating system, and a switching control unit that invokes the operating system switching function with the event information as an argument so that the secondary operating system will be switched in as the active operating system.

The primary operating system control unit further includes a switching decision unit which makes a decision as to whether the primary operating system can be put in a suspended state or not. If it is decided that the primary operating system can be put in a suspended state, the switching control unit instructs the operating system switching function to switch in the secondary operating system as the active operating system. The primary operating system control unit further includes a switching lock request receiving unit which receives a switching lock request that requests to inhibit the primary operating system from being suspended or to unlock the inhibited state. Based on the received switching lock request, the switching decision unit determines whether the primary operating system can be put in a suspended state or not.

It is also known to provide an information processing apparatus which includes a first virtual machine that executes a first operating system and a second virtual machine that executes a second operating system, and which sets one or the other of the first and second virtual machines to an active state ready for user operation. The first virtual machine includes a first device control unit which performs processing to recognize a device that operates only on the first operating system; there are also provided a device detection unit which detects a device connected signal when a new device is connected by a user, a setting unit which, in response to the detection of the connected signal, sets the first virtual machine to the active state even when the second virtual machine is in the active state, and a device management unit which activates the first device control unit, based on the detected device connected signal. The device here is a human interface device that operates only on the first operating system. The information processing apparatus further includes a human interface device switching unit which detects a switching signal when the human interface device is switched; in response to the detection of the switching signal, the setting unit sets the first virtual machine to the active state even when the second virtual machine is in the active state, and the device management unit activates the first device control unit, based on the detected switching signal.

It is further known to provide an information processing apparatus to which a user interface unit is connected and which executes programs on different kinds of OSs. Each OS writes screen video data to be displayed on a display unit into a corresponding virtual video memory area, and a virtual video memory area switching unit retrieves video data from a corresponding one of the virtual video memory areas and writes it into a video memory and, under instruction from an instruction unit, switches the virtual video memory area from which to retrieve the video data.

Related art is disclosed in Japanese Laid-open Patent Publications No. 2008-52714, No. 2008-269177, and No. 2010-55641.

### SUMMARY

According to the apparatus aspect of the invention, there is provided an information processing apparatus capable of running in parallel a plurality of operating systems including at least a first operating system and a second operating system. The information processing apparatus includes: a storage which stores screen data that each of the operating systems uses to produce a display screen on a display unit; a display controller which performs control to determine which of the display screens represented by the screen data stored in the storage is to be displayed; an input interface which accepts a user input operation and outputs an input event corresponding to the input operation; a first event controller which, when the first operating system, which is granted an input event receiving right, is enabled to accept a user authentication operation, and when the input event output from the input interface is not a predetermined first input event, then instructs the display controller to perform processing to display the display screen of the first operating system for accepting the authentication operation; and a second event controller which, when the input event output from the input interface is the first input event, then instructs the display controller to perform processing to display the display screen of the second operating system currently not displayed on the display unit.

According to the program aspect of the invention, there is provided a program that is executed on an information processing apparatus on which a plurality of operating systems, including at least a first operating system and a second operating system, are running in parallel. The program causes the information processing apparatus to carry out processing which includes: storing, in a storage provided within the information processing apparatus, screen data that each of the operating systems uses to produce a display screen on a display unit; accepting a user input operation and generating an input event corresponding to the input operation; when the first operating system, which is granted an input event receiving right from among the plurality of operating systems, is enabled to accept a user authentication operation, and when the input event is not a predetermined first input event, then displaying the display screen of the first operating system for accepting the authentication operation; and when the input event is the first input event, then displaying on the display unit the display screen of the second operating system currently not displayed on the display unit.

According to the method aspect of the invention, there is provided a screen display method for displaying a display screen generated by each of a plurality of operating systems, including at least a first operating system and a second operating system, that are running in parallel on an information processing apparatus. The screen display method includes: storing, in a storage provided within the information processing apparatus, screen data that each of the operating systems uses to produce a display screen on a display unit; causing an input interface to accept a user input operation and to generate an input event corresponding to the input operation; when the first operating system, which is granted an input event receiving right from among the plurality of operating systems, is enabled to accept a user authentication operation, and when the input event output from the input interface is not a predetermined first input event, then displaying the display screen of the first operating system for accepting the authentication operation; and when the input event output from the input interface is the first input event, then displaying on the display unit the display screen of the second operating system currently not displayed on the display unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of the hardware configuration of an information processing apparatus.

FIG. 2 is a diagram illustrating the external appearance of a first example of the information processing apparatus.

FIG. 3 is a diagram illustrating one configuration example of the information processing apparatus.

FIG. 4 is a diagram illustrating one example of an authentication prompt screen.

FIG. 5A is diagram illustrating examples of foreground OS information, resource management information, and lock state information, stored in a state storage unit (part 1).

FIG. 5B is diagram illustrating examples of foreground OS information, resource management information, and lock state information, stored in a state storage unit (part 2).

FIG. 5C is diagram illustrating examples of foreground OS information, resource management information, and lock state information, stored in a state storage unit (part 3).

FIG. 6 is a sequence diagram (part 1) illustrating a first example of the processing performed by the information processing apparatus.

FIG. 7 is a diagram illustrating how the display screen changes (part 1).

FIG. 8 is a sequence diagram (part 2) illustrating the first example of the processing performed by the information processing apparatus.

FIG. 9 is a diagram illustrating how the display screen changes (part 2).

FIG. 10 is a sequence diagram (part 3) illustrating the first example of the processing performed by the information processing apparatus.

FIG. 11 is a sequence diagram (part 4) illustrating the first example of the processing performed by the information processing apparatus.

FIG. 12 is an explanatory diagram illustrating the first example of the processing performed by the information processing apparatus.

FIG. 13 is a diagram illustrating the external appearance of a second example of the information processing apparatus.

FIG. 14 is a sequence diagram (part 1) illustrating a second example of the processing performed by the information processing apparatus.

FIG. 15 is a sequence diagram (part 2) illustrating the second example of the processing performed by the information processing apparatus.

FIG. 16 is a sequence diagram (part 3) illustrating the second example of the processing performed by the information processing apparatus.

FIG. 17A is an explanatory diagram (part 1) illustrating the second example of the processing performed by the information processing apparatus.

FIG. 17B is an explanatory diagram (part 2) illustrating the second example of the processing performed by the information processing apparatus.

### DESCRIPTION OF EMBODIMENTS

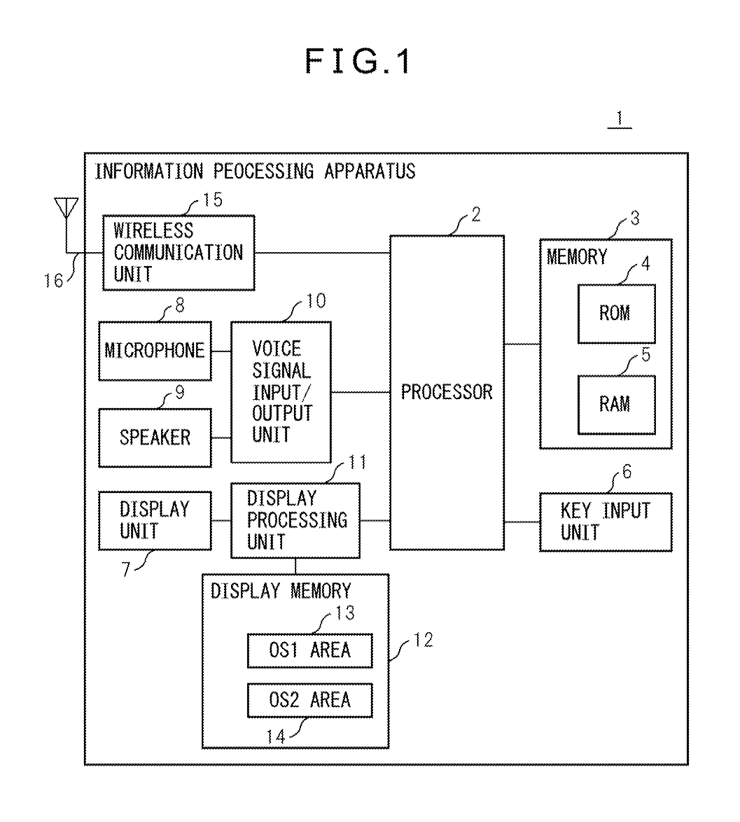

Embodiments will be described below with reference to the accompanying drawings. FIG. 1 is a diagram illustrating one example of the hardware configuration of an information processing apparatus. The hardware configuration illustrated in FIG. 1 is only one example of the hardware configuration for implementing the information processing apparatus 1. Any other hardware configuration may be employed as long as it implements the processing hereinafter described in this specification.

The information processing apparatus 1 includes a processor 2, a memory 3, a key input unit 6, a display unit 7, a microphone 8, a speaker 9, a voice signal input unit 10, a display processing unit 11, a display memory 12, a wireless communication unit 15, and an antenna 16.

The processor 2 executes a program stored in the memory 3. The program stored in the memory 3 causes the processor 2 to implement the processing to be described hereinafter for controlling the operation of the information processing apparatus 1. The memory 3 stores not only the program to be executed by the processor 2 but also data temporarily used by the program. The memory 3 may include a read only memory (ROM) 4 and a random access memory (RAM) 5. In an embodiment, the information processing apparatus 1 may include a hard disk or a nonvolatile memory or the like as the storage means.

The key input unit 6 is an input device that accepts input operations performed by the user of the information processing apparatus 1. The key input unit 6 may be a keypad or a keyboard. In an embodiment, some other input device may be used, instead of or in addition to the key input unit 6, to accept user input operations.

The display unit 7 is a display device that presents information processed by the information processing apparatus 1 to the user in a visual manner. The display unit 7 displays a screen generated by each of a plurality of OSs running on the information processing apparatus 1. The display unit 7 may be, for example, a liquid crystal display, a CRT (Cathode Ray Tube) display, or an organic electroluminescent display.

The microphone 8 is an input device which is primarily used to input a voice signal to the information processing apparatus 1, and the speaker 9 is an output device used to output the voice signal processed by the information processing apparatus 1. The voice signal input unit 10 is an interface between the information processing apparatus 1 and the microphone 8 and speaker 9, and may perform such processing as voice signal analog-to-digital conversion, digital-to-analog conversion, encoding, and decoding. In an embodiment, the microphone 8, the speaker 9, and the voice signal input unit 10 may be omitted.

The display processing unit 11 processes display data that the processor 2 stored in the display memory 12, and produces a visual display on the display unit 7. For each of the plurality of OSs running on the information processing apparatus 1, the display memory 12 allocates an area for storing screen data that the OS uses to produce a screen on the display unit 7. In the following description, the screen that each OS produces on the display unit 7 may be referred to as the “display screen”.

An OS1 area 13 and OS2 area 14 for storing the screen data that the first and second OSs running on the information processing apparatus 1 use to produce their respective display screens are depicted in FIG. 1. The display processing unit 11 retrieves the screen data stored in the OS1 area 13 or the OS2 area 14, depending on which OS display screen, the first OS or the second OS, is to be displayed on the display unit 7. The display processing unit 11 supplies the display screen represented by the retrieved data to the display unit 7.

The wireless communication unit 15 generates a radio frequency signal by encoding, modulating, and frequency-translating the baseband signal output from the processor 2, and transmits out the radio frequency signal via the antenna 16. The wireless communication unit 15 receives a radio frequency signal via the antenna 16, and frequency-translates, demodulates, and decodes it to the baseband signal. The wireless communication unit 15 supplies the baseband signal to the processor 2. In an embodiment, the wireless communication unit 15 and the antenna 16 may be omitted.

The memory 3, key input unit 6, display unit 7, microphone 8, speaker 9, and wireless communication unit 15 described above are managed by each OS as the hardware resources available to the plurality of OSs to be run on the information processing apparatus 1. The hardware resources available to each OS vary depending on whether the OS is run in the foreground or in the background.

Each OS can independently use the memory 3. The wireless communication unit 15 is shared by the plurality of OSs, and the foreground OS can also receive signals. In an embodiment, the foreground OS makes exclusive use of the key input unit 6, the display unit 7, the microphone 8, and the speaker 9.

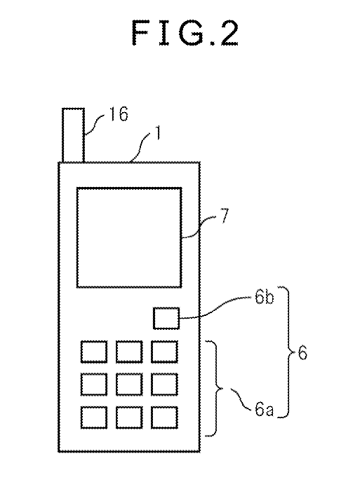

FIG. 2 is a diagram illustrating the external appearance of a first example of the information processing apparatus 1. In an embodiment, the information processing apparatus 1 may be, for example, a mobile phone, a personal computer, a personal digital assistant (PDA), an electronic book reader, an electronic personal organizer, or the like.

The key input unit 6, display unit 7, and antenna 16 of the information processing apparatus 1 as a portable information terminal are depicted in FIG. 2. The key input unit 6 includes a keypad 6a and an OS switching key 6b. In an embodiment, one of the keys on the keypad 6a may be configured to also function as the OS switching key 6b. For example, one of the keys on the keypad 6a may be configured to function either as a normal key on the keypad 6a or as the OS switching key 6b, depending on how it is depressed.

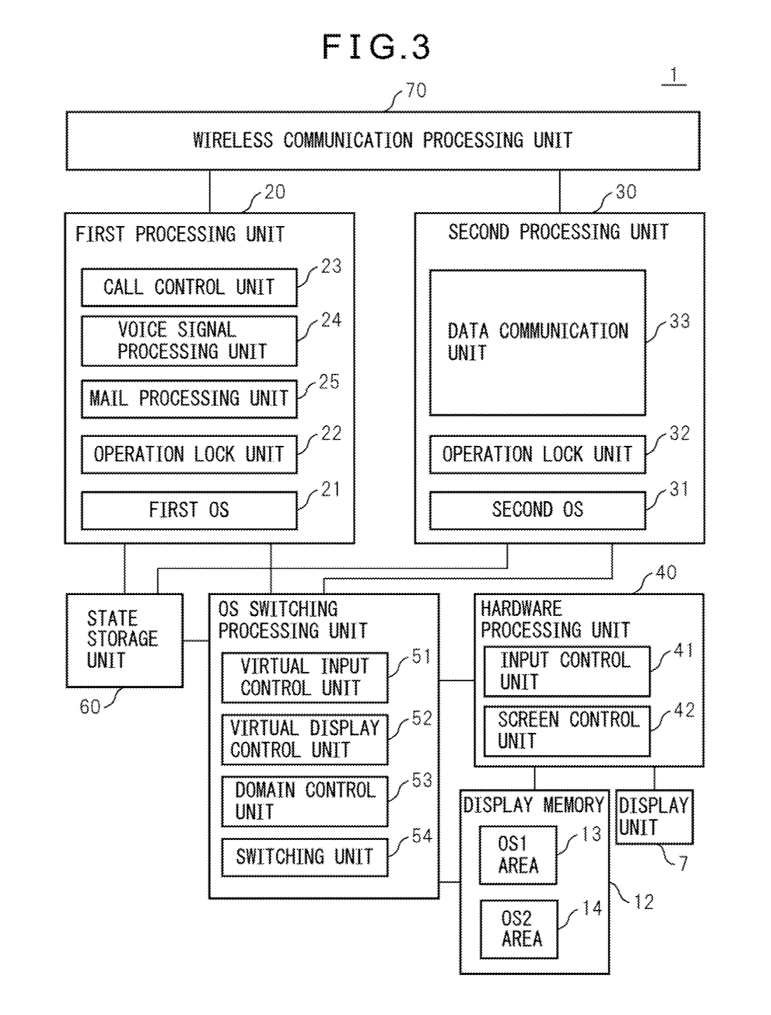

FIG. 3 is a diagram illustrating one configuration example of the information processing apparatus 1. The processor 2 in FIG. 1 performs information processing by using the component elements depicted in FIG. 3 in accordance with a program stored in the memory 3 and in cooperation with other component elements as needed. FIG. 3 specifically depicts the functions relevant to the description given hereinafter. The information processing apparatus 1 may also include other component elements than those depicted herein.

The information processing apparatus 1 includes a first processing unit 20, a second processing unit 30, a hardware processing unit 40, an OS switching processing unit 50, a state storage unit 60, and a wireless communication processing unit 70.

The first processing unit 20 performs information processing in accordance with a computer program executed on the first OS 21 that runs on the information processing apparatus 1. In an embodiment, the first processing unit 20 performs information processing for implementing a telephone service which is provided via the wireless communication processing unit 70. For example, the first processing unit 20 may include, in addition to the first OS 21, an operation lock unit 22, a call control unit 23, a voice signal processing unit 24, and a mail processing unit 25.

The operation lock unit 22 switches the state of the first OS 21 between the operation locked state and the operation unlocked state. The operation lock unit 22 may put the first OS 21 into the operation locked state, for example, if no user input operation has been received within a predefined period when the first OS 21 is running as the foreground OS. The operation lock unit 22 may also put the first OS 21 into the operation locked state, for example, if the information processing apparatus 1 is turned off or enters a power saving mode when the first OS 21 is running as the foreground OS. Further, the operation lock unit 22 puts the first OS 21 into the operation locked state in accordance with an instruction from a switching unit 54 to be described later.

When the user has performed a prescribed authentication operation, the operation lock unit 22 may cause the state of the first OS 21 to transition from the operation locked state to the operation unlocked state. When the first OS 21 is in the operation locked state, the operation lock unit 22 creates as the display screen of the first OS 21 an authentication prompt screen for accepting the user's authentication operation, and supplies the thus created screen to a virtual display control unit 52 to be described later.

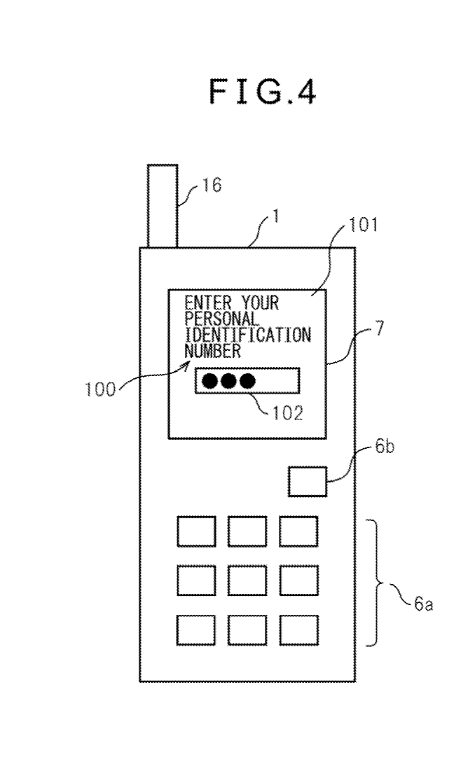

FIG. 4 illustrates one example of the authentication prompt screen. The authentication prompt screen 100 produced on the display unit 7 includes a message 101 prompting the user to enter his personal identification number as authentication information, and an entered digit indicator 102 which indicates the number of entered digits of the personal identification number being entered by the user. When the state of the first OS 21 is switched, the operation lock unit 22 updates lock state information stored in the state storage unit 60 for the first OS 21.

Reference is made back to FIG. 3. The call control unit 23 performs call control for the telephone service provided via the wireless communication processing unit 70. The voice signal processing unit 24 processes voice signals transmitted and received by the telephone service provided via the wireless communication processing unit 70. The processing performed by the voice signal processing unit 24 is carried out by a computer program executed on the first OS 21 in cooperation with the voice signal input/output unit 10 depicted in FIG. 1. The mail processing unit performs processing to transmit and receive short message services transmitted and received by the telephone service provided via the wireless communication processing unit 70.

The second processing unit 30 performs information processing in accordance with a computer program executed on the second OS 31 that runs on the information processing apparatus 1. In a certain embodiment, the second processing unit 30 performs information processing for implementing a data communication service which is provided via the wireless communication processing unit 70. For example, the second processing unit 30 may include, in addition to the second OS 31, an operation lock unit 32 and a data communication unit 33.

The operation lock unit 32 switches the state of the second OS 31 between the operation locked state and the operation unlocked state. The operation lock unit 32 may put the second OS 31 into the operation locked state, for example, if no user input operation has been received within a predefined period when the second OS 31 is running as the foreground OS. The operation lock unit 32 may also put the second OS 31 into the operation locked state, for example, if the information processing apparatus 1 is turned off or enters a power saving mode when the second OS 31 is running as the foreground OS. Further, the operation lock unit 32 puts the second OS 31 into the operation locked state in accordance with an instruction from the switching unit 54 to be described later.

When the user has performed a prescribed authentication operation, the operation lock unit 32 may cause the state of the second OS 31 to transition from the operation locked state to the operation unlocked state. When the second OS 31 is in the operation locked state, the operation lock unit 32 creates as the display screen of the second OS 31 an authentication prompt screen for accepting the user's authentication operation, and supplies the thus created screen to the virtual display control unit 52.

When the state of the second OS 31 is switched, the operation lock unit 32 updates lock state information stored in the state storage unit 60 for the second OS 31. The data communication unit 33 transmits and receives data transmitted and received by the data communication service provided via the wireless communication processing unit 70.

The hardware processing unit 40 receives an input operation accepted by the key input unit 6 depicted in FIG. 1 and a voice signal produced by the microphone 8, and outputs the display screen to the display unit 7 and the voice signal to the speaker 9. The hardware processing unit 40 includes an input control unit 41 and a screen control unit 42.

The input control unit 41 performs processing to receive the input operation accepted by the key input unit 6 and the voice signal produced by the microphone 8. The input control unit 41 receives the input operation that the user performed via the key input unit 6, and outputs an input event signal corresponding to the input operation. For example, when one of the keys on the keypad 6a is operated, the input control unit 41 outputs an input event signal indicating the occurrence of a keypad operation event. When the OS switching key 6b is operated, for example, the input control unit 41 outputs an input event signal indicating the occurrence of an OS switching key operation event. The input control unit 41 is an example of the input interface.

The screen control unit 42 performs processing to output the display screen to the display unit 7. As will be described later, the screen control unit 42 retrieves the screen data stored in the OS1 area 13 or the OS2 area 14, in accordance with an instruction from the virtual display control unit 52 indicating which OS display screen, the first OS 21 or the second OS 31, is to be displayed on the display unit 7. The screen control unit 42 supplies the display screen represented by the retrieved data to the display unit 7.

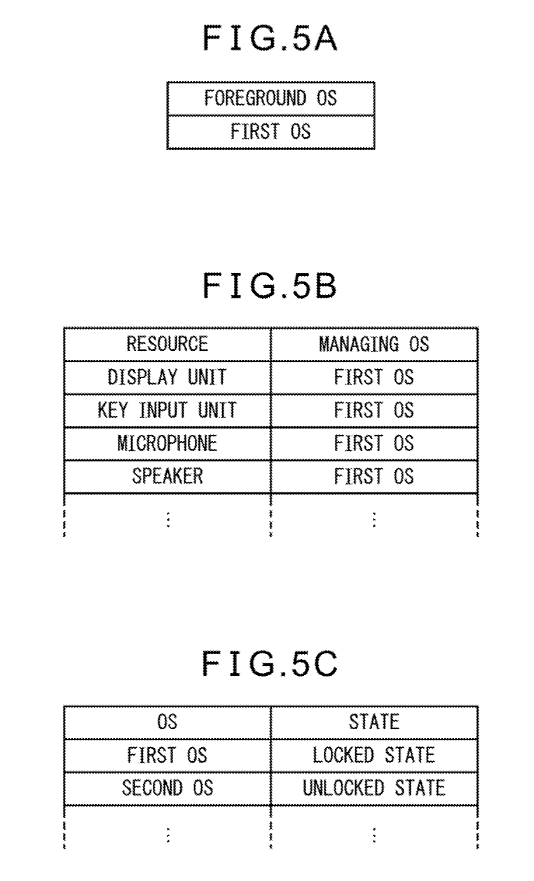

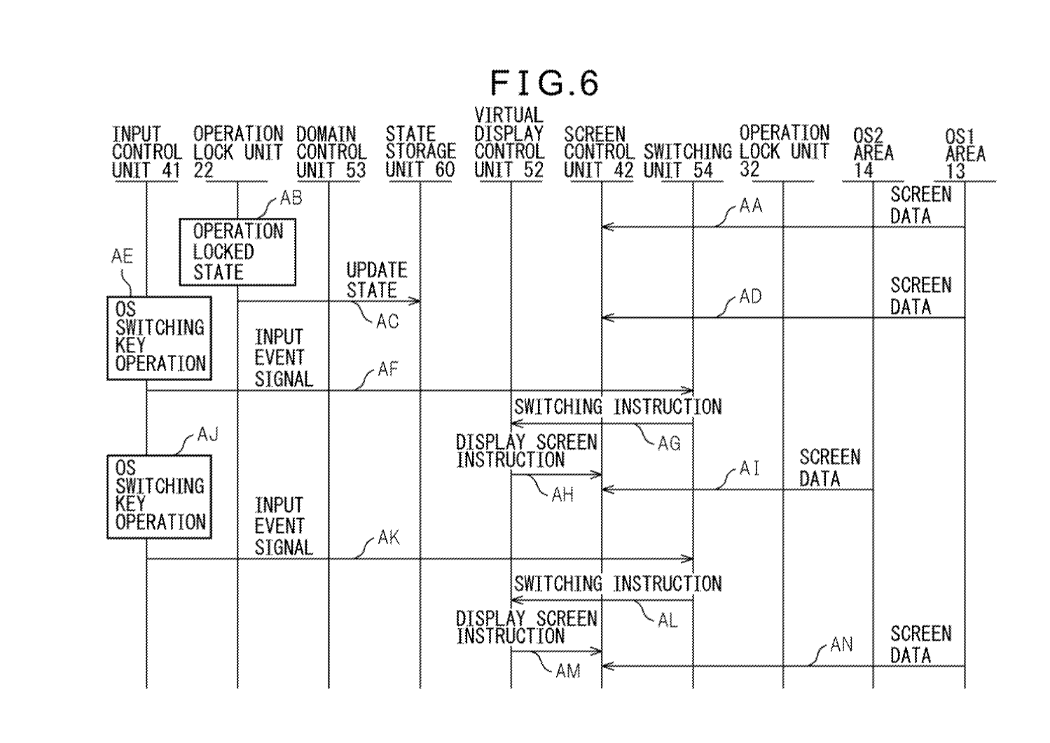

The state storage unit 60 stores information concerning the state of the information processing apparatus 1. For example, foreground OS information, resource management information, and lock state information are stored in the state storage unit 60. FIG. 5A to FIG. 5C are diagrams illustrating examples of the foreground OS information, the resource management information, and the lock state information, respectively.

The foreground OS information carries identification information of the OS currently running in the foreground. In the example of FIG. 5A, the first OS 21 is designated as the foreground OS. The resource management information carries identification information of the OS granted the right to use the hardware resources provided by the information processing apparatus 1. In the example of FIG. 5B, the right to use the display unit 7, key input unit 6, microphone 8, and speaker 9 as the hardware resources is granted to the first OS 21 designated as the foreground OS. The lock state information indicates which OS is in the locked state or which OS is in the unlocked state. In the example of FIG. 5C, the first OS 21 is in the locked state, and the second OS 31 is in the unlocked state.

Reference is made back to FIG. 3. The OS switching processing unit 50 performs processing to switch the foreground OS. The OS switching processing unit 50 includes a virtual input control unit 51 and a domain control unit 53 in addition to the virtual display control unit 52 and the switching unit 54. The virtual input control unit 51 supplies signals entered via the input devices, such as the key input unit 6 and the microphone 8, to the OS granted the right to use these device in accordance with the resource management information stored in the stage storage unit 60.

For example, the virtual input control unit 51 supplies the input event signal output from the input control unit 41 to the OS designated in the resource management information as the OS having the right to use the key input unit 6. In the following description, the right to use the key input unit 6 may be described as the “input event receiving right”.

The virtual display control unit 52 receives the screen data that the first OS 21 and the second OS 31 use to produce their respective display screens, and stores the data in the OS1 area 13 and the OS2 area 14, respectively. The virtual display control unit 52 determines which OS display screen, the first OS 21 or the second OS 31, is to be displayed on the display unit 7, in accordance with a switching instruction from the switching unit 54 to be described later. The virtual display control unit 52 indicates to the screen control unit 42 which OS display screen is to be displayed on the display unit 7. The virtual display control unit 52 is one example of the display control unit.

The domain control unit 53 performs processing to switch the foreground OS. The domain control unit 53 is one example of the right controller. The domain control unit 53 may accomplish the processing for switching the foreground OS in accordance with the switching instruction from the switching unit 54 to be described later.

When switching the foreground OS, the domain control unit 53 updates the OS identification information carried in the foreground OS information stored in the state storage unit 60 to the OS identification information designating the foreground OS after the switching. The domain control unit 53 also updates the resource management information. The domain control unit 53 transfers the exclusive right granted to the foreground OS to use the hardware resources to the OS designated as the foreground OS after the switching.

The switching unit 54 receives the input event signal from the input control unit 41. The switching unit 54 performs the following processing, depending on whether the input event is the OS switching key operation event or not, whether the foreground OS is in the operation locked state or not, and which OS display screen is currently displayed on the display unit 7. The switching unit 54 here is one example of the first event processing unit, the second event processing unit, or the state changing unit.

(1) The OS switching key operation event has occurred while the display screen of the foreground OS is displayed and while the foreground OS is in the operation unlocked state.

In this case, the switching unit 54 instructs the domain control unit 53 to switch the foreground OS. The switching unit 54 also instructs the virtual display control unit 52 to switch the display screen so that the display screen of the OS newly designated as the foreground OS is displayed on the display unit 7. For example, if the OS switching key operation event has occurred when the first OS 21 is currently designated as the foreground OS, then if the first OS 21 currently running as the foreground OS is in the operation unlocked state, the display screen of the second OS 31 newly designated as the foreground OS is displayed on the display unit 7.

(2) The OS switching key operation event has occurred while the display screen of the foreground OS is displayed and while the foreground OS is in the operation locked state.

In this case, the switching unit 54 instructs the virtual display control unit 52 to switch the display screen so that the display screen of the background OS is displayed on the display unit 7. At this stage, the switching unit 54 does not instruct the domain control unit 53 to switch the OS.

(3) The OS switching key operation event has occurred while the display screen of the background OS is displayed and while the foreground OS is in the operation locked state.

In this case, the switching unit 54 instructs the virtual display control unit 52 to switch the display screen so that the display screen of the foreground OS is displayed on the display unit 7. The switching unit 54 does not instruct the domain control unit 53 to switch the OS.

(4) An event due to the operation of a key other than the OS switching key 6b has occurred while the display screen of the background OS is displayed and while the foreground OS is in the operation locked state.

In this case, the switching unit 54 instructs the domain control unit 53 to switch the foreground OS. The switching unit 54 sets the new foreground OS to the operation locked state. That is, the switching unit 54 synchronizes the operation locked state between the foreground OS and the background OS.

In this case, the switching unit 54 instructs the operation lock unit operating on the new foreground OS to put the new foreground OS into the operation locked state. Further, the switching unit 54 updates the lock state information stored in the state storage unit 60.

(5) An event due to the operation of a key other than the OS switching key 6b has occurred while the display screen of the foreground OS is displayed and while the foreground OS is in the operation locked state.

In this case, the switching unit 54 instructs the virtual display control unit 52 to perform processing so that the authentication prompt screen of the foreground OS is displayed on the display unit 7.

The wireless communication processing unit 70 performs processing to transmit and receive wireless communication signals that the information processing apparatus 1 transmits and receives. The processing performed by the wireless communication processing unit 70 is carried out by a computer program executed on the first OS 21 in cooperation with the wireless communication unit 15 depicted in FIG. 1.

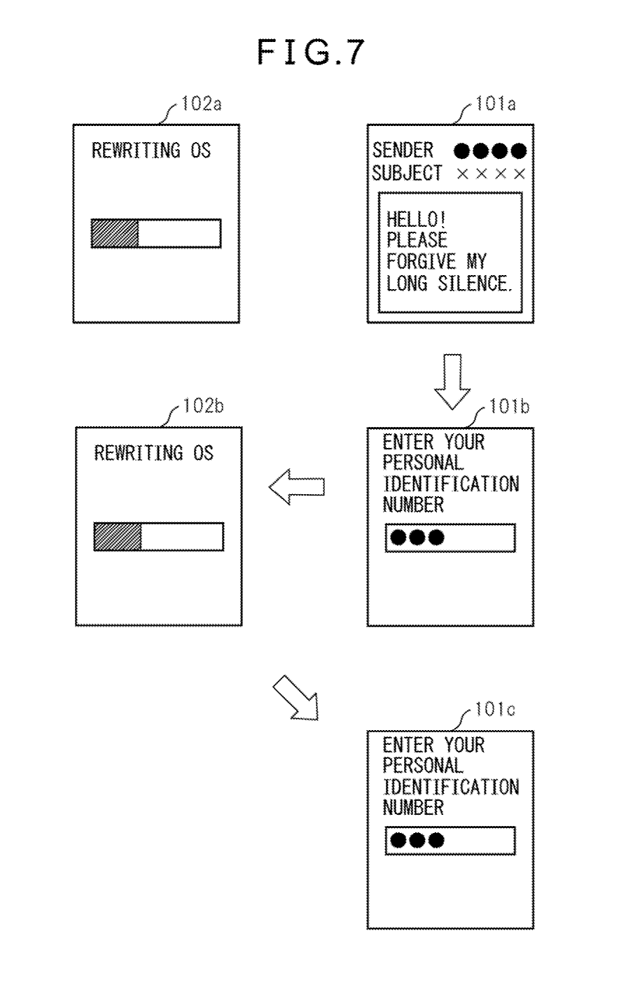

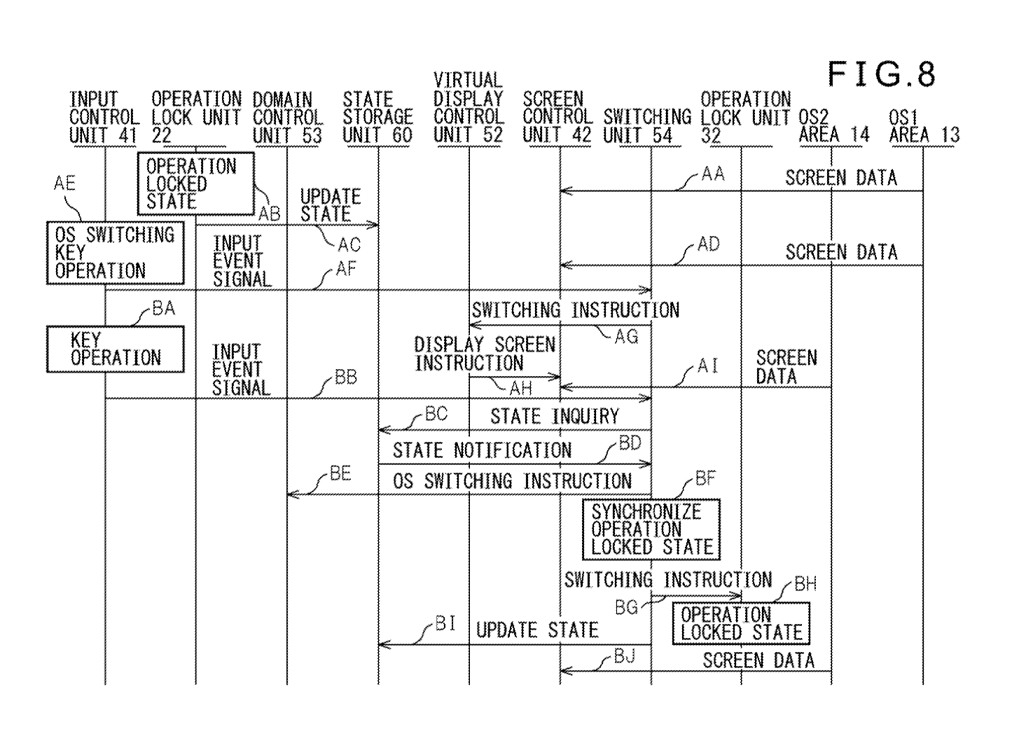

Next, the processing performed by the information processing apparatus 1 will be described. FIG. 6 is a sequence diagram illustrating a first example of the processing performed by the information processing apparatus 1, and FIG. 7 is a diagram illustrating how the display screen displayed on the display unit 7 changes in conjunction with the sequence depicted in FIG. 6.

The following describes the processing for viewing the display screen of the second OS 31 running in the background when the first OS 21 is running as the foreground OS. If the terms “first OS 21” and “second OS 31” are interchanged, the following also describes the processing for viewing the display screen of the first OS 21 running in the background when the second OS 31 is running as the foreground OS. In an alternative embodiment, the following operations AA to AN may be implemented as steps.

In operation AA, the screen control unit 42 retrieves from the OS1 area 13 the screen data used to produce the display screen of the first OS 21 running in the foreground, and displays it on the display unit 7. Reference numeral 101a in FIG. 7 indicates an example of the display screen of the first OS 21 displayed on the display unit 7 in operation AA. The display screen of the second OS 31 as the background OS at this point in time is indicated by reference numeral 102a. At this time, the display unit 7 displays the display screen of the first OS 21, but does not display the display screen of the second OS 31.

In operation AB, the operation lock unit 22 puts the first OS 21 into the operation locked state. In operation AC, the operation lock unit 22 updates the lock state information stored in the state storage unit 60 for the first OS 21.

Further, the operation lock unit 22 creates as the display screen of the first OS 21 an authentication prompt screen for accepting the user's authentication operation. In operation AD, the screen control unit 42 retrieves from the OS1 area 13 the screen data used to produce the authentication prompt screen, and displays it on the display unit 7. Reference numeral 101b in FIG. 7 indicates the authentication prompt screen of the first OS 21.

When the OS switching key 6b is operated in operation AE, the input control unit 41 in operation AF outputs an input event signal indicating the occurrence of an OS switching key operation event.

At the time that the switching unit 54 receives this input event signal, the display screen of the foreground OS is displayed, and the foreground OS is in the operation locked state. Accordingly, the switching unit 54 performs the processing for the earlier described case (2). That is, in operation AG, the switching unit 54 instructs the virtual display control unit 52 to perform processing so that the display screen of the second OS 31 as the background OS is displayed on the display unit 7.

In operation AH, the virtual display control unit 52 instructs the screen control unit 42 to display the display screen of the second OS 31. In operation AI, the screen control unit 42 retrieves the screen data from the OS2 area 14 and displays it on the display unit 7. Reference numeral 102b in FIG. 7 depicts the display screen of the second OS 31 displayed on the display unit 7.

When the OS switching key 6b is operated in operation AJ, the input control unit 41 in operation AK outputs an input event signal indicating the occurrence of the OS switching key operation event.

At the time that the switching unit 54 receives this input event signal, the display screen of the background OS is displayed, and the foreground OS is in the operation locked state. Accordingly, the switching unit 54 performs the processing for the earlier described case (3). That is, in operation AL, the switching unit 54 instructs the virtual display control unit 52 to perform processing so that the display screen of the first OS 21 as the foreground OS is displayed on the display unit 7.

In operation AM, the virtual display control unit 52 instructs the screen control unit 42 to display the display screen of the first OS 21. In operation AN, the screen control unit 42 retrieves the screen data from the OS1 area 13 and displays it on the display unit 7. Reference numeral 101c in FIG. 7 depicts the authentication prompt screen of the first OS 21 displayed on the display unit 7.

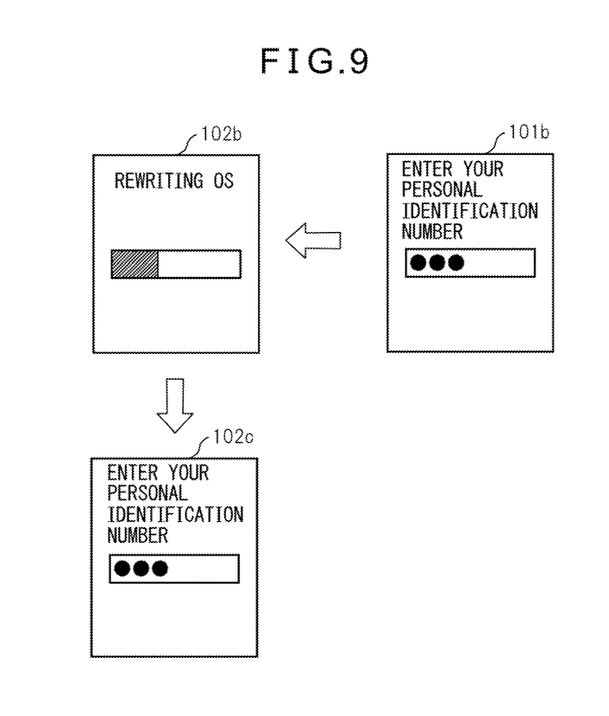

Next, referring to FIG. 8, a description will be given of the processing performed when a key other than the OS switching key 6b is operated while the display screen of the background OS is displayed. FIG. 9 is a diagram illustrating how the display screen displayed on the display unit 7 changes in conjunction with the sequence depicted in FIG. 8. In an alternative embodiment, the following operations AA to AI and BA to BJ may be implemented as steps.

The processing from operations AA to AI in FIG. 8 is the same as the processing from operations AA to AI in FIG. 6. Reference numerals 101b and 102b in FIG. 9 indicate the display screens of the first OS 21 and the second OS 31 displayed in operations AD and AI, respectively.

When a key other than the OS switching key 6b is operated in operation BA, the input control unit 41 in operation BB outputs an input event signal indicating the occurrence of an event due to the operation of a key other than the OS switching key 6b.

At the time that the switching unit 54 receives this input event signal, the display screen of the background OS is displayed, and the foreground OS is in the operation locked state. Accordingly, the switching unit 54 performs the processing for the earlier described case (4). That is, in operation BC, the switching unit 54 refers to the state storage unit 60 for the lock state information for the first OS 21 and the second OS 31, respectively. In operation BD, the state storage unit 60 sends the lock state information for the first OS 21 and the second OS 31 to the switching unit 54.

In operation BE, the switching unit 54 instructs the domain control unit 53 to switch the foreground OS. The domain control unit 53 performs processing to switch the foreground OS. The second OS 31 thus becomes the foreground OS.

In operation BF, the switching unit 54 synchronizes the operation locked state between the foreground OS and the background OS. At this time, the switching unit 54 checks whether the first OS 21 is in the operation locked state. If the first OS 21 is in the operation locked state, the switching unit 54 in operation BG instructs the switching lock unit 32 to put the second OS into the operation locked state. In operation BH, the switching lock unit 32 puts the second OS 31 into the operation locked state. The operation lock unit 32 creates as the display screen of the second OS 31 an authentication prompt screen for accepting the user's authentication operation.

In operation BI, the switching unit 54 updates the lock state information stored in the state storage unit 60 for the second OS 31. In operation BJ, the screen control unit 42 retrieves from the OS2 area 14 the screen data used to produce the authentication prompt screen, and displays it on the display unit 7. Reference numeral 102c in FIG. 9 indicates the authentication prompt screen of the second OS 31.

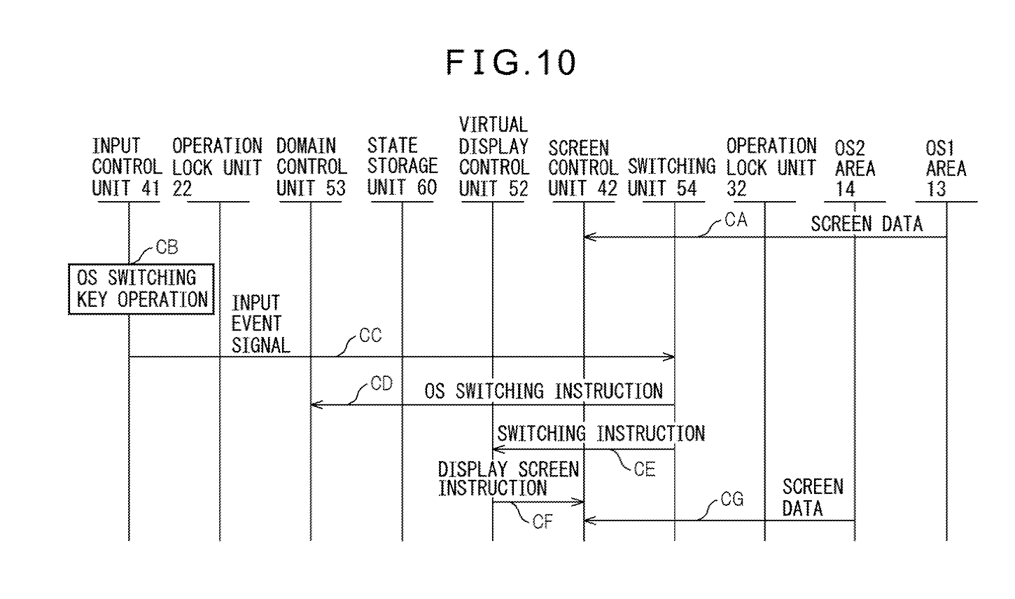

Next, referring to FIG. 10, a description will be given of the processing when the OS switching key operation event has occurred while the display screen of the foreground OS is displayed and while the foreground OS is in the operation unlocked state. Here, the switching unit 54 performs the processing for the earlier described case (1). In an alternative embodiment, the following operations CA to CG may be implemented as steps.

In operation CA, the screen control unit 42 retrieves from the OS1 area 13 the screen data used to produce the display screen of the first OS 21 running in the foreground, and displays it on the display unit 7. When the OS switching key 6b is operated in operation CB, the input control unit 41 in operation CC outputs an input event signal indicating the occurrence of the OS switching key operation event.

In operation CD, the switching unit 54 that received the input event signal instructs the domain control unit 53 to switch the foreground OS. The domain control unit 53 performs processing to switch the foreground OS. The second OS 31 thus becomes the foreground OS.

In operation CE, the switching unit 54 instructs the virtual display control unit 52 to perform processing so that the display screen of the second OS 31 as the foreground OS is displayed on the display unit 7. In operation CF, the virtual display control unit 52 instructs the screen control unit 42 to display the display screen of the second OS 31. In operation CG, the screen control unit 42 retrieves the screen data from the OS2 area 14 and displays it on the display unit 7.

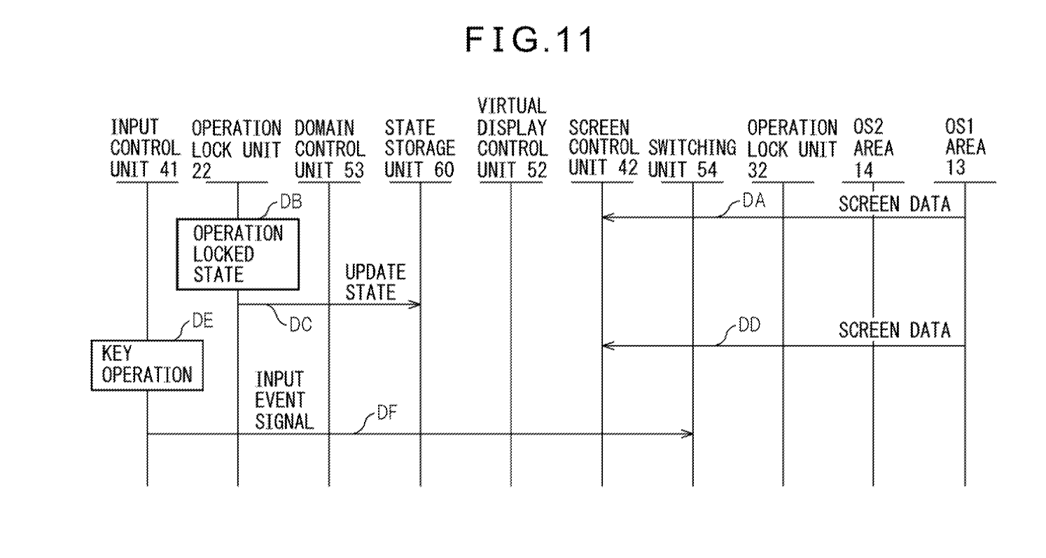

Next, referring to FIG. 11, a description will be given of the processing when an event due to the operation of a key other than the OS switching key 6b has occurred while the display screen of the foreground OS is displayed and while the foreground OS is in the operation locked state. Here, the switching unit 54 performs the processing for the earlier described case (5). In an alternative embodiment, the following operations DA to DF may be implemented as steps.

In operation DA, the screen control unit 42 retrieves from the OS1 area 13 the screen data used to produce the display screen of the first OS 21 running in the foreground, and displays it on the display unit 7. In operation DB, the operation lock unit 22 puts the first OS 21 into the operation locked state. In operation DC, the operation lock unit 22 updates the lock state information stored in the state storage unit 60 for the first OS 21.

Further, the operation lock unit 22 creates as the display screen of the first OS 21 an authentication prompt screen for accepting the user's authentication operation. In operation DD, the screen control unit 42 retrieves from the OS1 area 13 the screen data used to produce the authentication prompt screen, and displays it on the display unit 7.

When a key other than the OS switching key 6b is operated in operation DE, the input control unit 41 in operation DF outputs an input event signal indicating the occurrence of an event due to the operation of a key other than the OS switching key 6b. The switching unit 54 that received the input event signal instructs the virtual display control unit 52 to perform processing so that the authentication prompt screen of the first OS 21 as the foreground OS is displayed as it is received. Based on the authentication information entered from the authentication prompt screen by using keys other than the OS switching key 6b, the operation lock unit 22 determines whether or not to unlock the operation locked state.

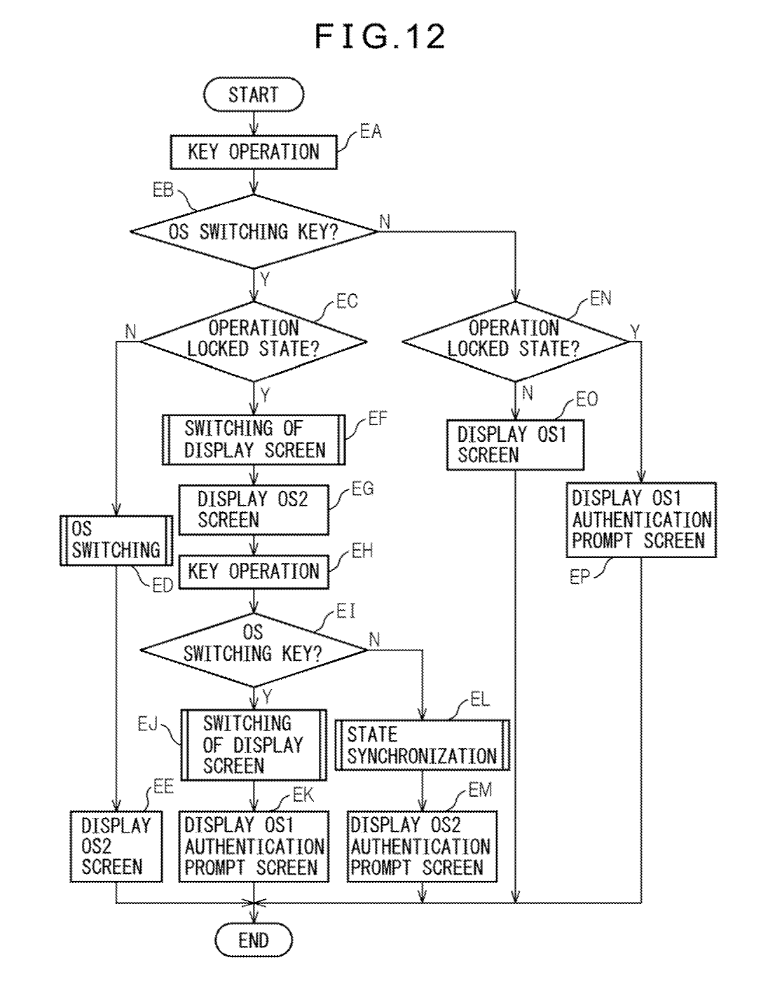

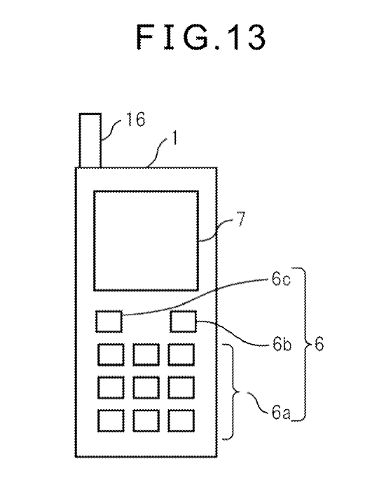

Next, the series of processing operations performed by the information processing apparatus 1 will be described. FIG. 12 is an explanatory diagram illustrating the first example of the processing performed by the information processing apparatus 1. In an alternative embodiment, the following operations EA to EP may be implemented as steps.

In operation EA, the key input unit 6 accepts a user input key operation. The input control unit 41 sends the input event signal to the switching unit 54. In operation EB, the switching unit 54 determines whether the input event is the OS switching key operation event or not. If the input event is the OS switching key operation event (Y in operation EB), the process proceeds to operation EC. If the input event is not the OS switching key operation event (N in operation EB), the process proceeds to operation EN.

In operation EC, the switching unit 54 refers to the state storage unit 60 for the lock state information for the first OS 21. The switching unit 54 determines whether the first OS 21 is in the operation locked state. If the first OS 21 is in the operation locked state (Y in operation EC), the process proceeds to operation EF. If the first OS 21 is not in the operation locked state (N in operation EC), the process proceeds to operation ED.

In operation ED, the switching unit 54 instructs the domain control unit 53 to switch the foreground OS. The domain control unit 53 performs processing to switch the foreground OS. The second OS 31 thus becomes the foreground OS.

In operation EE, the switching unit 54 instructs the virtual display control unit 52 to perform processing so that the display screen of the second OS 31 as the foreground OS is displayed on the display unit 7. The virtual display control unit 52 instructs the screen control unit 42 to display the display screen of the second OS 31. The screen control unit 42 displays the display screen of the second OS 31 on the display unit 7.

In operation EF, the switching unit 54 instructs the virtual display control unit 52 to perform processing so that the display screen of the second OS 31 as the background OS is displayed on the display unit 7. In operation EG, the virtual display control unit 52 instructs the screen control unit 42 to display the display screen of the second OS 31. The screen control unit 42 displays the display screen of the second OS 31 on the display unit 7.

In operation EH, the key input unit 6 accepts a user input key operation. The input control unit 41 sends the input event signal to the switching unit 54. In operation EI, the switching unit 54 determines whether the input event is the OS switching key operation event or not. If the input event is the OS switching key operation event (Y in operation EI), the process proceeds to operation EJ. If the input event is not the OS switching key operation event (N in operation EI), the process proceeds to operation EL.

In operation EJ, the switching unit 54 instructs the virtual display control unit 52 to perform processing so that the display screen of the first OS 21 as the foreground OS is displayed on the display unit 7. In operation EK, the virtual display control unit 52 instructs the screen control unit 42 to display the display screen of the first OS 21. The screen control unit 42 displays the authentication prompt screen on the display unit 7 as the display screen of the first OS 21.

In operation EL, the switching unit 54 instructs the domain control unit 53 to switch the foreground OS. The domain control unit 53 performs processing to switch the foreground OS. The second OS 31 thus becomes the foreground OS. The switching unit 54 synchronizes the operation locked state between the foreground OS and the background OS. As a result, the second OS 31 is also put into the operation locked state.

In operation EM, the switching unit 54 instructs the virtual display control unit 52 to perform processing so that the display screen of the second OS 31 as the foreground OS is displayed on the display unit 7. The virtual display control unit 52 instructs the screen control unit 42 to display the display screen of the second OS 31. The screen control unit 42 displays the authentication prompt screen of the second OS 31 on the display unit 7.

In operation EN, the switching unit 54 refers to the state storage unit 60 for the lock state information for the first OS 21. The switching unit 54 determines whether the first OS 21 is in the operation locked state. If the first OS 21 is in the operation locked state (Y in operation EN), the process proceeds to operation EP. If the first OS 21 is not in the operation locked state (N in operation EN), the process proceeds to operation EO.

In operation EO, the screen control unit 42 displays on the display unit 7 the display screen of the first OS 21 appropriate to the input key operation. On the other hand, in operation EP, the screen control unit 42 displays the authentication prompt screen of the first OS 21 on the display unit 7.

According to the present embodiment, when the OS switching key 6b is operated, the information processing apparatus 1 can display the display screen of the background OS on the display unit 7 without having to switch the foreground OS. As a result, even in a situation where the use of the background OS by the user is restricted, the user can readily view the display screen of the background OS.

For example, even when the foreground OS is in the operation locked state, the user can view the display screen of the background OS without performing an authentication operation. Further, even when the processing load of the background OS is high or when the background OS does not provide the service supposed to be provided to the user, the user can readily view the display screen of the background OS.

According to the present embodiment, when the foreground OS is in the operation locked state, if the OS switching key 6b is operated while the display screen of the background OS is displayed, the display screen switches back to the display screen of the foreground OS. When a key other than the switching key 6b is operated, the state of the background OS is also changed to the operation locked state. As a result, when the foreground OS is in the operation locked state, if the background OS is displayed, the user is inhibited from performing operations other than the screen switching operation. The present embodiment can thus facilitate easy switching of the display screen while ensuring security.

Next, an alternative embodiment of the information processing apparatus 1 will be described. FIG. 13 is a diagram illustrating the external appearance of a second example of the information processing apparatus 1. The key input unit 6 of the information processing apparatus 1 as a portable information terminal includes a keypad 6a, an OS switching key 6b, and a screen switching key 6c. When the screen switching key 6c is operated, the input control unit 41 depicted in FIG. 3 outputs an input event signal indicating the occurrence of a screen switching key operation event.

The switching unit 54 performs the following processing, depending on whether the input event is the OS switching key operation event or not, whether the input event is the screen switching key operation event or not, whether the foreground OS is in the operation locked state or not, and which OS display screen is currently displayed on the display unit 7.

The processing for the cases (1), (2), and (3) is the same as the processing for the previously described cases.

(14) An event due to the operation of a key, other than the OS switching key 6b or the screen switching key 6c, has occurred while the display screen of the background OS is displayed and while the foreground OS is in the operation locked state.

The processing is the same as the processing for the previously described case (4).

(15) An event due to the operation of a key, other than the OS switching key 6b or the screen switching key 6c, has occurred while the display screen of the foreground OS is displayed and while the foreground OS is in the operation locked state.

The processing is the same as the processing for the previously described case (5).

(16) The screen switching key operation event has occurred while the display screen of the background OS is displayed and while the foreground OS is in the operation locked state.

In this case, the switching unit 54 instructs the virtual display control unit 52 to switch the display screen so that the display screen of the foreground OS is displayed on the display unit 7. The switching unit 54 does not instruct the domain control unit 53 to switch the OS.

(17) The screen switching key operation event has occurred while the display screen of the background OS is displayed and while the foreground OS is in the operation unlocked state.

The processing is the same as the processing for the above case (16).

(18) An event due to the operation of a key, other than the OS switching key 6b or the screen switching key 6c, has occurred while the display screen of the background OS is displayed and while the foreground OS is in the operation unlocked state.

The switching unit 54 discards the input event output from the input control unit 41.

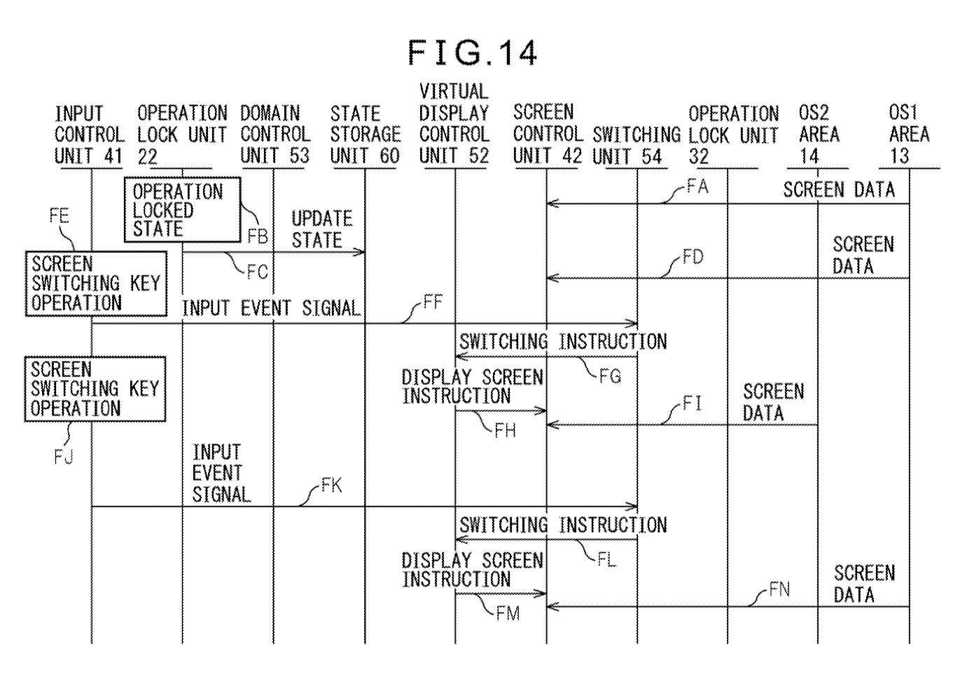

Next, the operation of the information processing apparatus 1 for the case (16) will be described with reference to FIG. 14. In an alternative embodiment, the following operations FA to FN may be implemented as steps.

The processing from operations FA to FD is the same as the processing from operations AA to AD in FIG. 6. When the screen switching key 6c is operated in operation FE, the input control unit 41 in operation FF outputs an input event signal indicating the occurrence of the screen switching key operation event.

In operation FG, the switching unit 54 that received the input event signal instructs the virtual display control unit 52 to perform processing so that the display screen of the second OS 31 as the background OS is displayed on the display unit 7. In operation FH, the virtual display control unit 52 instructs the screen control unit 42 to display the display screen of the second OS 31. In operation FI, the screen control unit 42 retrieves the screen data from the OS2 area 14, and displays it on the display unit 7.

When the screen switching key 6c is operated in operation FJ, the input control unit 41 in operation FK outputs an input event signal indicating the occurrence of the screen switching key operation event.

In operation FL, the switching unit 54 that received the input event signal instructs the virtual display control unit 52 to perform processing so that the display screen of the first OS 21 as the foreground OS is displayed on the display unit 7. In operation FM, the virtual display control unit 52 instructs the screen control unit 42 to display the display screen of the first OS 21. In operation FN, the screen control unit 42 retrieves the screen data from the OS1 area 13, and displays it on the display unit 7.

As can be seen from the above operations FA to FJ, switching of the foreground OS does not occur when the screen switching key 6c is operated.

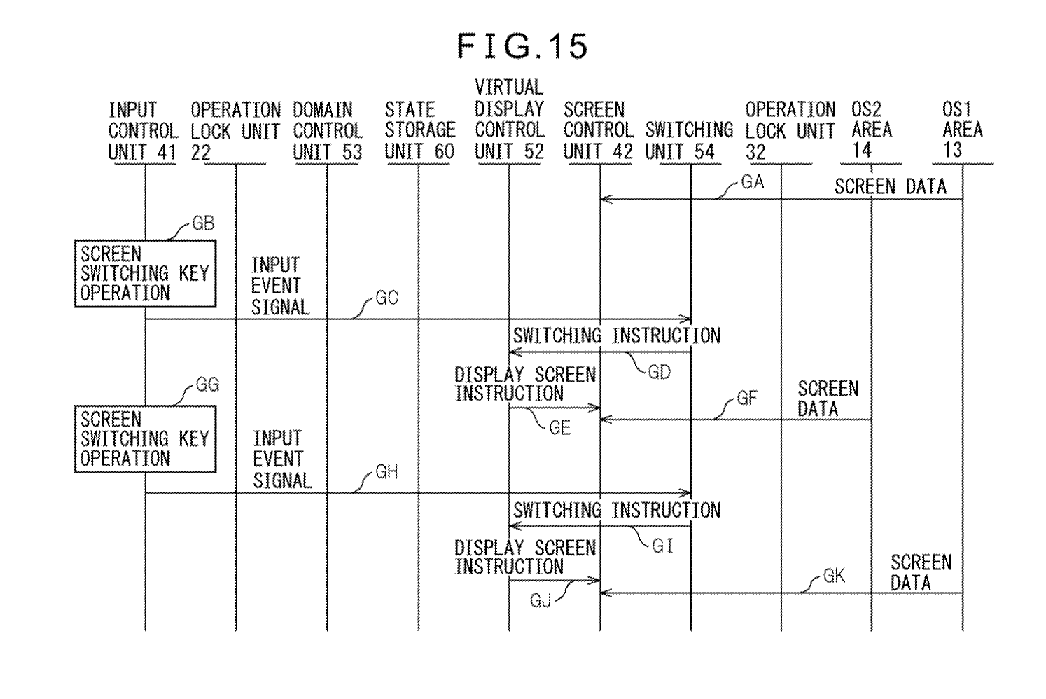

Next, the operation of the information processing apparatus 1 for the case (17) will be described with reference to FIG. 15. In an alternative embodiment, the following operations GA to GK may be implemented as steps.

In operation GA, the screen control unit 42 retrieves from the OS1 area 13 the screen data used to produce the display screen of the first OS 21 running in the foreground, and displays it on the display unit 7. The processing in the following operations GB to GK is the same as the processing performed in the operations FE to FN depicted in FIG. 14, except that the first OS 21 running in the foreground is in the operation unlocked state. Accordingly, as can be seen from the operations GA to GK, switching of the foreground OS does not occur when the screen switching key 6c is operated, whether the foreground OS be in the operation locked state or in the operation unlocked state.

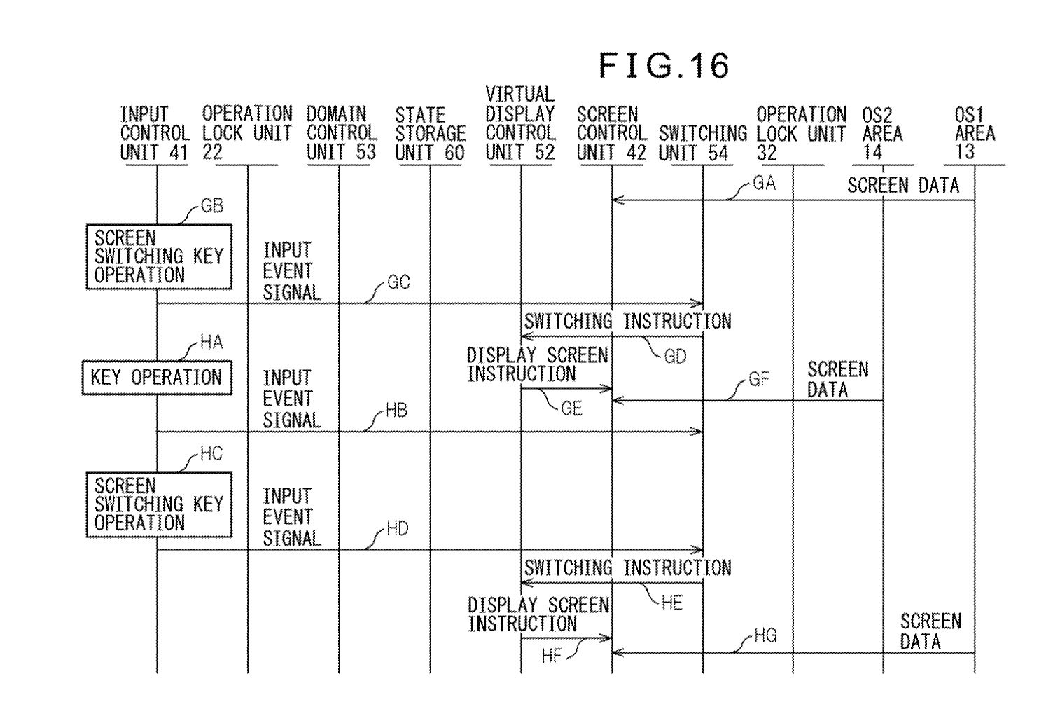

Next, the operation of the information processing apparatus 1 for the case (18) will be described with reference to FIG. 16. In an alternative embodiment, the following operations GA to GF and HA to HG may be implemented as steps.

The processing from operations GA to GF in FIG. 16 is the same as the processing from operations GA to GF in FIG. 15. In operation HA, a key, other than the OS switching key 6b or the screen switching key 6c, is operated. In operation HB, the input control unit 41 outputs an input event signal indicating the occurrence of an event due to the operation of a key other than the OS switching key 6b or the screen switching key 6c.

The switching unit 54 that received the input event signal instructs the input control unit 41 to discard this input event. Accordingly, the input control unit 41 does not supply this input event to the first OS 21 nor to the second OS 31. The switching unit 54 waits for an input event signal to be output from the input control unit 41 due to the occurrence of the OS switching key operation event or the screen switching key operation event.

In operation HC, the screen switching key 6c is operated. The subsequent processing from operation HD to operation HG is the same as the processing from operation GH to operation GK in FIG. 15. In this way, according to the present embodiment, if any key, other than the OS switching key 6b or the screen switching key 6c, is operated while the display screen of the background OS is displayed and while the foreground OS is in the operation unlocked state, the input event associated with such a key input is discarded. This serves to prevent an input event that the user has entered to the background OS from being erroneously supplied to the foreground OS.

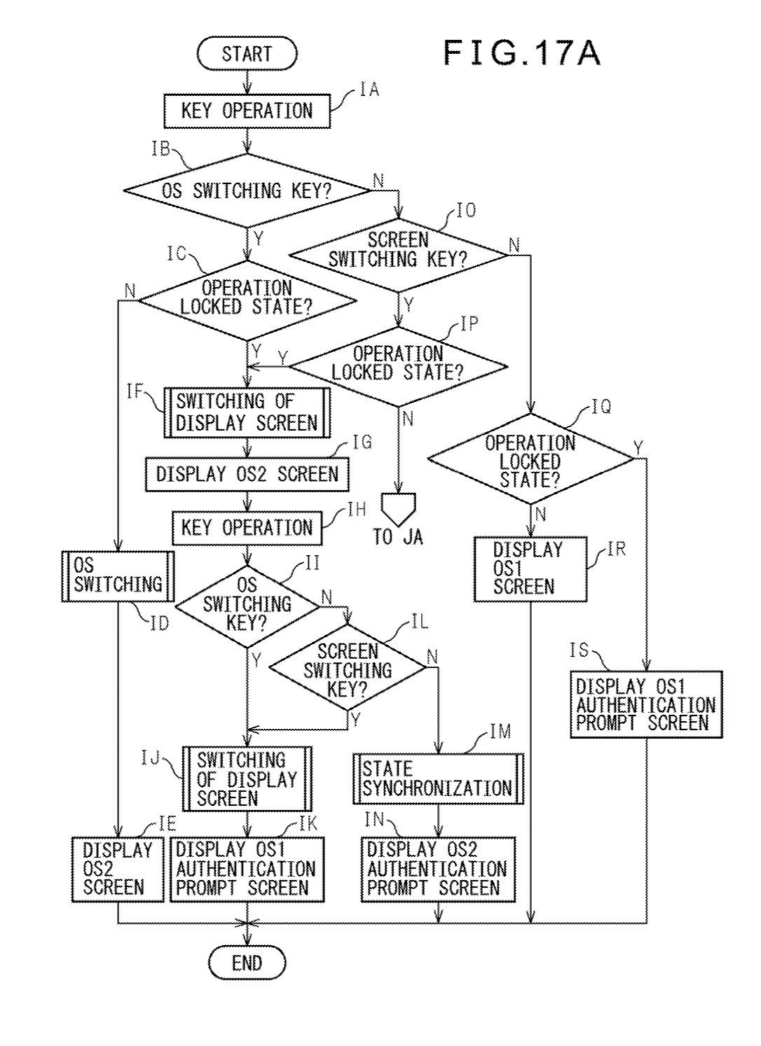

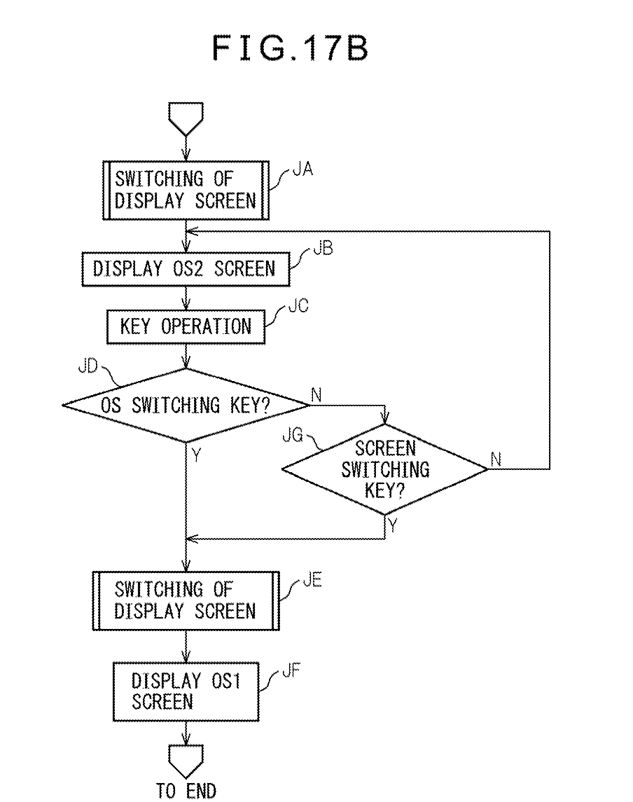

Next, the series of processing operations performed by the second example of the information processing apparatus 1 will be described with reference to FIG. 17A and FIG. 17B. In an alternative embodiment, the following operations IA to IS and JA to JF may be implemented as steps.

Operations IA to IH are the same as the corresponding operations EA to EH in FIG. 12. In operation II, the switching unit 54 determines whether the input event is the OS switching key operation event or not. If the input event is the OS switching key operation event (Y in operation II), the process proceeds to operation IJ. If the input event is not the OS switching key operation event (N in operation II), the process proceeds to operation IL.

In operation IJ, the switching unit 54 instructs the virtual display control unit 52 to perform processing so that the display screen of the first OS 21 as the foreground OS is displayed on the display unit 7. In operation IK, the virtual display control unit 52 instructs the screen control unit 42 to display the display screen of the first OS 21. The screen control unit 42 displays the authentication prompt screen on the display unit 7 as the display screen of the first OS 21.

In operation IL, the switching unit 54 determines whether the input event is the screen switching key operation event or not. If the input event is the screen switching key operation event (Y in operation IL), the process proceeds to operation IJ. If the input event is not the screen switching key operation event (N in operation IL), the process proceeds to operation IM.

In operation IM, the switching unit 54 instructs the domain control unit 53 to switch the foreground OS. The domain control unit 53 performs processing to switch the foreground OS. The switching unit 54 synchronizes the operation locked state between the foreground OS and the background OS.

In operation IN, the switching unit 54 instructs the virtual display control unit 52 to perform processing so that the display screen of the second OS 31 as the foreground OS is displayed on the display unit 7. The virtual display control unit 52 instructs the screen control unit 42 to display the display screen of the second OS 31. The screen control unit 42 displays the authentication prompt screen of the second OS 31 on the display unit 7.

In operation IO, the switching unit 54 determines whether the input event is the screen switching key operation event or not. If the input event is the screen switching key operation event (Y in operation IO), the process proceeds to operation IP. If the input event is not the screen switching key operation event (N in operation IO), the process proceeds to operation IQ.

In operation IP, the switching unit 54 refers to the state storage unit 60 for the lock state information for the first OS 21. The switching unit 54 determines whether the first OS 21 is in the operation locked state. If the first OS 21 is in the operation locked state (Y in operation IP), the process proceeds to operation IF. If the first OS 21 is not in the operation locked state (N in operation IP), the process proceeds to operation JA.

In operation IQ, the switching unit 54 refers to the state storage unit 60 for the lock state information for the first OS 21. The switching unit 54 determines whether the first OS 21 is in the operation locked state. If the first OS 21 is in the operation locked state (Y in operation IQ), the process proceeds to operation IR. If the first OS 21 is not in the operation locked state (N in operation IQ), the process proceeds to operation IS.

In operation IR, the screen control unit 42 displays on the display unit 7 the display screen of the first OS 21 appropriate to the input key operation. On the other hand, in operation IS, the screen control unit 42 displays the authentication prompt screen of the first OS 21 on the display unit 7.

In operation JA, the switching unit 54 instructs the virtual display control unit 52 to perform processing so that the display screen of the second OS 31 as the background OS is displayed on the display unit 7. In operation JB, the virtual display control unit 52 instructs the screen control unit 42 to display the display screen of the second OS 31. The screen control unit 42 displays the display screen of the second OS 31 on the display unit 7.

In operation JC, the key input unit 6 accepts a user input key operation. The input control unit 41 sends the input event signal to the switching unit 54. In operation JD, the switching unit 54 determines whether the input event is the OS switching key operation event or not. If the input event is the OS switching key operation event (Y in operation JD), the process proceeds to operation JE. If the input event is not the OS switching key operation event (N in operation JD), the process proceeds to operation JG.

In operation JE, the switching unit 54 instructs the virtual display control unit 52 to perform processing so that the display screen of the first OS 21 as the foreground OS is displayed on the display unit 7. In operation JF, the virtual display control unit 52 instructs the screen control unit 42 to display the display screen of the first OS 21. The screen control unit 42 displays the authentication prompt screen on the display unit 7 as the display screen of the first OS 21.

In operation JG, the switching unit 54 determines whether the input event is the screen switching key operation event or not. If the input event is the screen switching key operation event (Y in operation JG), the process proceeds to operation JE. If the input event is not the screen switching key operation event (N in operation JG), the process returns to operation JB.

According to the present embodiment, since the switching of the foreground OS does not occur when the screen switching key 6c is operated, the user can readily view the display screen of the background OS. For example, even when high-load processing is being performed by the background OS, operating the screen switching key 6c does not cause the current background OS to be switched to the foreground OS. Thus, according to the present embodiment, the processing for switching the high-load background OS to the foreground OS is prevented from being erroneously initiated and thus causing a delay in accomplishing the screen switching.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An information processing apparatus capable of running in parallel a plurality of operating systems including at least a first operating system and a second operating system, comprising:
a storage which stores screen data that each of said operating systems uses to produce a display screen on a display unit;
a display controller which performs control to determine which of said display screens represented by said screen data stored in said storage is to be displayed;
an input interface which accepts a user input operation and outputs an input event corresponding to said input operation;
a first event controller which, when said first operating system, which is granted an input event receiving right from among said plurality of operating systems, is enabled to accept a user authentication operation, and when said input event output from said input interface is not a predetermined first input event, then instructs said display controller to perform processing to display the display screen of said first operating system for accepting said authentication operation; and
a second event controller which, when said input event output from said input interface is said first input event, then instructs said display controller to perform processing to display the display screen of said second operating system currently not displayed on said display unit.

2. An information processing apparatus as claimed in claim 1, further comprising a right controller which, when said first operating system is not enabled to accept said authentication operation, and when said input event output from said input interface is said first input event, then performs processing so that said input event receiving right currently granted to said first operating system is transferred to said second operating system.
